(19) United States
(12) Patent Application Publication
(10) Pub. No.: US 2017/0203666 A1
(43) Pub. Date: Jul. 20, 2017

(54) BATTERY CHARGING SYSTEM AND SERVICING METHOD

(71) Applicant: FORD GLOBAL TECHNOLOGIES, LLC, Dearborn, MI (US)

(72) Inventors: Felicia SUN, Canton, MI (US); William David TREHARNE, Ypsilanti, MI (US)

(21) Appl. No.: 15/000,323

(22) Filed: Jan. 19, 2016

(51) Int. Cl. B60L 11/18

(52) U.S. Cl. CPC B60L 11/1864; B60L 11/1816; B60L 11/1838

(57) ABSTRACT

A vehicle servicing method according to an exemplary aspect of the present disclosure incomes, among other things, disconnecting a high voltage battery pack of an electrified vehicle from a high voltage bus, connecting an external energy source to an inverter system controller after disconnecting the high voltage battery pack, starting an engine of the electrified vehicle using energy from an external energy source, and charging the high voltage battery pack using power from the engine.

### TECHNICAL FIELD

This disclosure relates to a vehicle servicing method for servicing an electrified vehicle. The vehicle servicing method is utilized to recharge a deeply depleted high voltage battery pack during engine fault conditions if the high voltage battery pack has an insufficient amount of charge for starting the engine.

### BACKGROUND

The need to reduce automotive fuel consumption and emissions is well known. Therefore, vehicles are being developed that reduce or completely eliminate reliance on internal combustion engines. Electrified vehicles are one type of vehicle currently being developed for this purpose. In general, electrified vehicles differ from conventional motor vehicles because they are selectively driven by one or more battery powered electric machines. Conventional motor vehicles, by contrast, rely exclusively on the internal combustion engine to drive the vehicle.

A full hybrid electric vehicle has two energy sources—fuel and a high voltage battery pack. The high voltage battery pack is used to start the engine, and the engine is employable to regeneratively recharge the battery pack when the state of charge (SOC) of the battery pack drops below a certain threshold value. The SOC of the battery pack can become depleted to the point that an insufficient amount of power is available to start the engine.

### SUMMARY

A vehicle servicing method according to an exemplary aspect of the present disclosure incomes, among other things, connecting an external energy source to an inverter system controller after disconnecting a high voltage battery pack from an external energy source, starting an engine of the electrified vehicle using energy from the external energy source, and charging the high voltage battery pack using power from the engine.

In a further non-limiting embodiment of the foregoing method, the method includes, after starting the engine, commanding a motor to output zero torque such that it is neither generating nor accepting any energy.

In a further non-limiting embodiment of either of the foregoing methods, disconnecting the high voltage battery pack includes unplugging a high voltage cable connected to the high voltage battery pack from the inverter system controller.

In a further non-limiting embodiment of any of the foregoing methods, the method includes, prior to charging the battery pack, commanding the inverter system controller to discharge a high voltage bus, disconnecting the external energy source after discharging the high voltage bus, reconnecting the high voltage battery pack to the high voltage bus prior to charging the high voltage battery pack, commanding the engine to produce torque, and commanding the inverter system controller to deliver power to charge the battery pack.

In a further non-limiting embodiment of any of the foregoing methods, the method includes, after connecting the external energy source, boosting incoming voltage from the external energy source.

In a further non-limiting embodiment of any of the foregoing methods, starting the engine includes invoking a low power cranking mode to start the engine and declaring the engine started if a speed of the engine exceeds a predefined value.

In a further non-limiting embodiment of any of the foregoing methods, the method includes setting engine to engine speed control and setting a motor to torque control mode.

In a further non-limiting embodiment of any of the foregoing methods, the method includes connecting a service tool to the electrified vehicle prior to performing the vehicle servicing method.

In a further non-limiting embodiment of any of the foregoing methods, the method includes communicating messages to a service technician on the service tool.

In a further non-limiting embodiment of any of the foregoing methods, charging the high voltage battery pack includes commanding the engine to produce torque and generate power to charge the high voltage battery pack.

In a further non-limiting embodiment of any of the foregoing methods, the method includes discharging the high voltage bus after starting the engine.

In a further non-limiting embodiment of any of the foregoing methods, charging the high voltage battery includes closing at least one contactor of the high voltage battery to reconnect the high voltage battery to the high voltage bus.

In a further non-limiting embodiment of any of the foregoing methods, the vehicle servicing method is performed in response to an engine fault condition if the high voltage battery pack has an insufficient amount of power necessary to start the engine.

A battery charging system according to another exemplary aspect of the present disclosure includes, among other things, a high voltage battery pack, an engine, an external energy source and an inverter system controller configured to start the engine using power from the external energy source during a first step of a vehicle servicing method and supply power from the engine to recharge the high voltage battery pack during a second step of the vehicle servicing method.

In a further non-limiting embodiment of the foregoing system, the system includes a service tool configured to communicate with the inverter system controller.

In a further non-limiting embodiment of either of the foregoing systems, the system includes an electric motor configured to start the engine in response to a command from the inverter system controller.

In a further non-limiting embodiment of any of the foregoing systems, the external energy source is a separate component from an electrified vehicle but the high voltage battery pack, the engine and the inverter system controller are each components of the electrified vehicle.

In a further non-limiting embodiment of any of the foregoing systems, the high voltage battery pack includes at least one battery cell and at least one contactor.

In a further non-limiting embodiment of any of the foregoing systems, the inverter system controller includes a plurality of switching devices configured to control bidirectional flow of power between the high voltage battery pack and the engine.

In a further non-limiting embodiment of any of the foregoing systems, the external energy source is a lead acid battery charger.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a powertrain of an electrified vehicle.

FIG. 2 illustrates a battery charging system of an electrified vehicle.

FIG. 3 schematically illustrates a vehicle servicing method for charging a deeply depleted high voltage battery pack of an electrified vehicle during engine fault conditions.

### DETAILED DESCRIPTION

This disclosure details an exemplary vehicle servicing method for charging a deeply depleted high voltage battery pack of an electrified vehicle. In some embodiments, the vehicle servicing method is employed during engine fault conditions to first start the engine and then regen charge the battery pack. The high voltage battery pack is first disconnected from a high voltage bus. An external energy source is then connected to the high voltage bus. The engine of the electrified vehicle is started using energy from the electrical energy source, and the high voltage battery pack is subsequently reconnected to the high voltage bus. The high voltage battery pack is regeneratively charged using power from the engine. A battery charging system is also proposed for executing the vehicle servicing method. These and other features are discussed in greater detail in the following paragraphs of this detailed description.

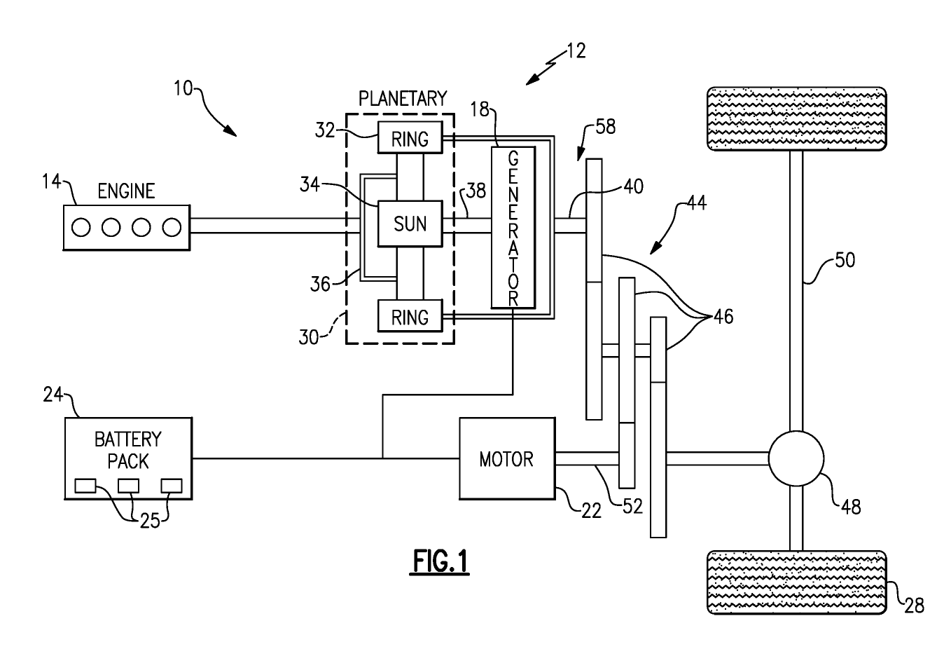

FIG. 1 schematically illustrates a powertrain 10 for an electrified vehicle 12. Although depicted as a hybrid electric vehicle (HEV), it should be understood that the concepts described herein are not limited to HEV's and could extend to other electrified vehicles, including, but not limited to, plug-in hybrid electric vehicles (PHEV's), battery electric vehicles (BEV's) and fuel cell vehicles.

In one non-limiting embodiment, the powertrain 10 is a power-split powertrain system that employs a first drive system and a second drive system. The first drive system includes a combination of an engine 14 and a generator 18 (i.e., a first electric machine). The second drive system includes at least a motor 22 (i.e., a second electric machine) and a battery pack 24. In this example, the second drive system is considered an electric drive system of the powertrain 10. The first and second drive systems generate torque to drive one or more sets of vehicle drive wheels 28 of the electrified vehicle 12. Although a power-split configuration is shown, this disclosure extends to any hybrid or electric vehicle including full hybrids, parallel hybrids, series hybrids, mild hybrids or micro hybrids.

The engine 14, which in one embodiment is an internal combustion engine, and the generator 18 may be connected through a power transfer unit 30, such as a planetary gear set. Of course, other types of power transfer units, including other gear sets and transmissions, may be used to connect the engine 14 to the generator 18. In one non-limiting embodiment, the power transfer unit 30 is a planetary gear set that includes a ring gear 32, a sun gear 34, and a carrier assembly 36.

The generator 18 can be driven by the engine 14 through the power transfer unit 30 to convert kinetic energy to electrical energy. The generator 18 can alternatively function as a motor to convert electrical energy into kinetic energy, thereby outputting torque to a shaft 38 connected to the power transfer unit 30. Because the generator 18 is operatively connected to the engine 14, the speed of the engine 14 can be controlled by the generator 18.

The ring gear 32 of the power transfer unit 30 may be connected to a shaft 40, which is connected to vehicle drive wheels 28 through a second power transfer unit 44. The second power transfer unit 44 may include a gear set having a plurality of gears 46. Other power transfer units may also be suitable. The gears 46 transfer torque from the engine 14 to a differential 48 to ultimately provide traction to the vehicle drive wheels 28. The differential 48 may include a plurality of gears that enable the transfer of torque to the vehicle drive wheels 28. In one embodiment, the second power transfer unit 44 is mechanically coupled to an axle 50 through the differential 48 to distribute torque to the vehicle drive wheels 28. In one embodiment, the power transfer units 30, 44 are part of a transmission 58 of the electrified vehicle 12.

The motor 22 can also be employed to drive the vehicle drive wheels 28 by outputting torque to a shaft 52 that is also connected to the second power transfer unit 44. In one embodiment, the motor 22 is part of a regenerative braking system. For example, the motor 22 can each output electrical power to the battery pack 24.

The battery pack 24 is an exemplary electrified vehicle battery. The battery pack 24 may be a high voltage traction battery pack that includes a plurality of battery assemblies 25 (i.e., battery arrays or groupings of battery cells) capable of outputting electrical power to operate the motor 22, the generator 18 and/or other electrical loads of the electrified vehicle 12. Other types of energy storage devices and/or output devices can also be used to electrically power the electrified vehicle 12.

In one non-limiting embodiment, the electrified vehicle 12 has two basic operating modes. The electrified vehicle 12 may operate in an Electric Vehicle (EV) mode where the motor 22 is used (generally without assistance from the engine 14) for vehicle propulsion, thereby depleting the battery pack 24 state of charge up to its maximum allowable discharging rate under certain driving patterns/cycles. The EV mode is an example of a charge depleting mode of operation for the electrified vehicle 12. During EV mode, the state of charge of the battery pack 24 may increase in some circumstances, for example due to a period of regenerative braking. The engine 14 is generally OFF under a default EV mode but could be operated as necessary based on a vehicle system state or as permitted by the operator.

The electrified vehicle 12 may additionally operate in a Hybrid (HEV) mode in which the engine 14 and the motor 22 are both used for vehicle propulsion. The HEV mode is an example of a charge sustaining mode of operation for the electrified vehicle 12. During the HEV mode, the electrified vehicle 12 may reduce the motor 22 propulsion usage in order to maintain the state of charge of the battery pack 24 at a constant or approximately constant level by increasing the engine 14 propulsion. The electrified vehicle 12 may be operated in other operating modes in addition to the EV and HEV modes within the scope of this disclosure.

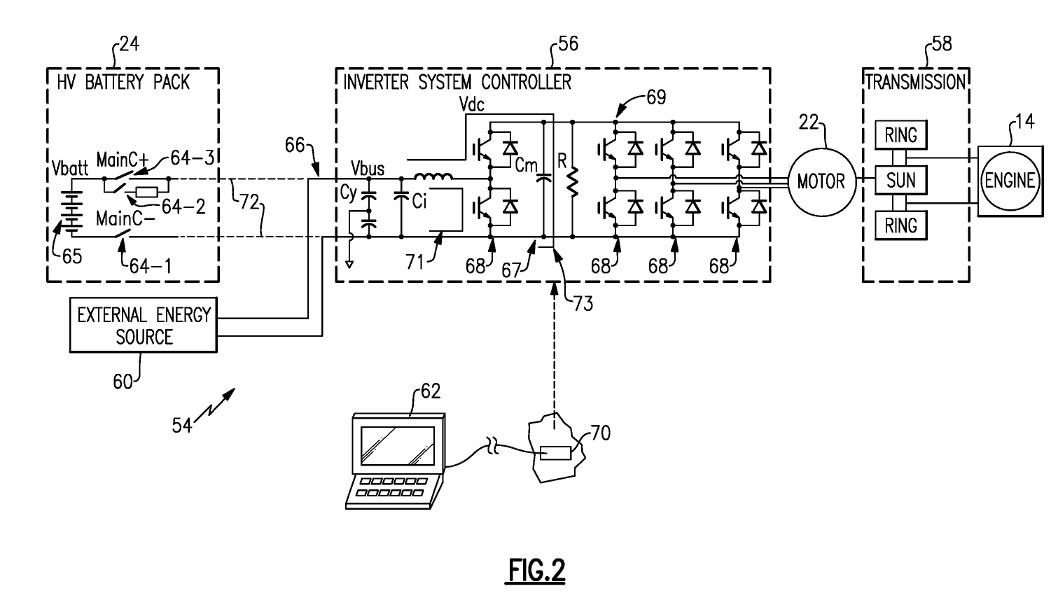

FIG. 2 illustrates a battery charging system 54 configured for recharging the energy storage devices (e.g., battery cells 65) of the high voltage battery pack 24. For example, the battery charging system 54 can be used to charge the battery pack 24 if an engine fault condition has occurred and the battery pack 24 has an insufficient SOC available for starting the engine 14. Exemplary engine fault conditions include low fuel pump pressure, faulty spark plug(s), blown fuse, or incorrect fuel source. Of course, these are non-limiting examples and are not intended to limit this disclosure.

The exemplary battery charging system 54 includes the battery pack 24, an inverter system controller (ISC) 56, the motor 22, the transmission 58 and the engine 14. The battery charging system 54 additionally includes an external energy source 60 and a service tool 62 that may be utilized by a service technician to execute an exemplary vehicle servicing method, as is further discussed below.

The battery pack 24 includes one or more battery cells 65 and contactors 64. The contractors 64 are selectively opened/closed to disconnect/connect the battery cells 65 of the battery pack 24 to a high voltage bus 66. For example, the contactors 64 are selectively closed to apply the DC voltage from the battery pack 24 to the high voltage bus 66, and are selectively opened to disconnect the battery pack 24 from the high voltage bus 66. In one non-limiting embodiment, the contactors 64 are controlled by a control module (not shown), such as a battery energy control module (BECM). In another non-limiting embodiment, a high voltage cable 72 connects the battery pack 24 to the ISC 56.

In one non-limiting embodiment, the ISC 56 is an inverter system controller combined with a variable voltage converter. The ISC 56 includes a plurality of switching devices 68 for controlling bi-directional power flow within the battery charging system 54. In one non-limiting embodiment, the switching devices 68 are insulated-gate bipolar transistors (IGBT's). The switching devices 68 are selectively commanded to undergo switching operations for converting DC voltage from the battery pack 24 to three phase AC voltage for supplying power to the motor 22 (i.e., to propel the vehicle), or alternatively, to covert AC three phase voltage to DC voltage for electric regenerative charging the battery cells 65 of the battery pack 24.

The transmission 58 includes the gear systems necessary for utilizing the power from the motor 22 to start the engine 14 during vehicle starting conditions. The transmission 58 also transfers the power from the engine 14 to the motor 22 for regeneratively charging the battery pack 24.

Unlike the battery pack 24, the ISC 56, the motor 22, the transmission 58 and the engine 14, the external energy source 60 is a separate component from the electrified vehicle. The external energy source 60 is connectable to the ISC 56 during certain conditions, such as engine fault conditions, and can be used to start the engine 14 if the battery pack 24 is deeply depleted. In one non-limiting embodiment, the external energy source 60 is a lead acid battery charger. In another non-limiting embodiment, the external energy source 60 is a low voltage battery. Other external energy sources are also contemplated within the scope of this disclosure.

The service tool 62 is connectable for communicating with the electrified vehicle. In one non-limiting embodiment, the service tool 62 is a computer that can be plugged into a data port 70 located onboard the electrified vehicle to access the vehicle's computer network. The service tool 62 enables a service technician to initiate vehicle servicing methods for servicing the electrified vehicle.

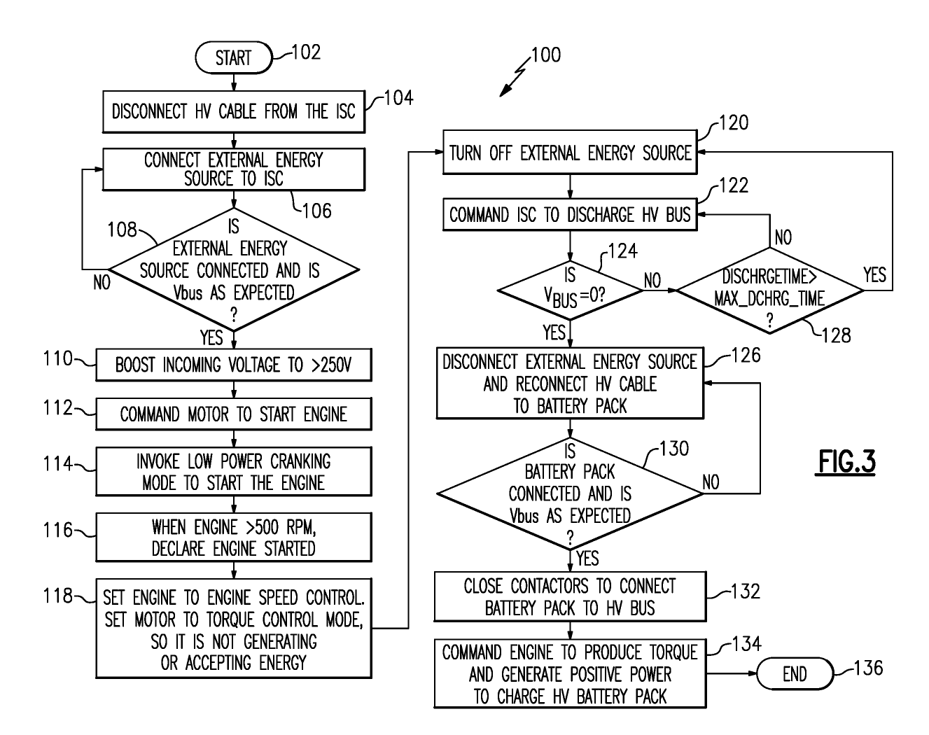

FIG. 3, with continued reference to FIGS. 1 and 2, schematically illustrates an exemplary vehicle servicing method 100. In one non-limiting embodiment, the vehicle servicing method 100 is executed by a service technician to recharge the battery pack 24 during engine fault conditions if the battery cells 65 of the battery pack 24 are depleted to such a low level that an insufficient amount of power is available for starting the engine 14.

The vehicle serving method 100 begins at block 102. By this time, the service technician has already connected the service tool 62 to the data port 70 of the electrified vehicle 12 and has confirmed that an engine fault condition has occurred and that the battery pack 24 includes an insufficient SOC for starting the engine 14. In one non-limiting embodiment, the ISC 56 checks the operating conditions of the electrified vehicle (e.g., vehicle is parked, speed is zero, etc.) and verifies the engine fault condition once the service technician has requested the vehicle servicing method 100.

At block 104, the high voltage cable 72 that extends between the battery pack 24 and the ISC 56 is disconnected from the ISC 56. Next, at block 106, the external energy source 60 is connected to the ISC 56 and is enabled for use (e.g., turned ON). In one non-limiting embodiment, the service technician can be informed to connect the external energy source 60 to the ISC 56, such as by communicating a message that is displayed by the service tool 62. The ISC 56 next verifies if the external energy source 60 is connected to the ISC 56 and that the DC voltage V_{bus} received from the external energy source 60 is within an expected range at block 108. This may be done using a high voltage interlock (HVIL), in one non-limiting embodiment. The HVIL may be performed by either the ISC 56 or a control module, such as the BECM.

The ISC 56 boosts the input voltage received from the external energy source 60, such as to a value above 250 volts, at block 110 if the external energy source 60 is connected and the V_{bus} is within the expected range. Next, at block 112, the ISC 56 commands the motor 22 to generate enough power to start the engine 14. In one non-limiting embodiment, the ISC 56 commands the motor 22 to generate around 500 W of power to start the engine 14. A low power cranking mode is invoked at block 114 (e.g., at least 250 RPMs), and when the engine 14 is operating at greater than 500 RPMs, the engine 14 is declared started at block 116.

At block 118, the engine 14 is set to engine speed control and the motor 22 is commanded to output zero torque such that it is neither generating nor accepting any energy. The service technician is then informed to turn the external energy source 60 OFF at block 120.

The ISC 56 is subsequently commanded to discharge the high voltage bus 66 at block 122. Discharging the high voltage bus 66 includes discharging the energy stored in capacitors Cy and Ci. When the external energy source 60 is used to start the engine 14, the energy is stored in capacitors Cy, Ci and Cm. The energy is removed as a safety precaution before disconnecting the high voltage cable 72 from the ISC 56. When a lower leg 67 of the switching devices is closed and an upper leg 69 is open, the energy stored in the capacitors Cy, Ci may be discharged along a path 71. Alternatively, if the upper leg 69 is closed and the lower leg 67 is open, the energy may be discharged along a path 73.

The DC voltage Vbus is monitored at block 124. In one non-limiting embodiment, the DC voltage Vbus is monitored by comparing it to the discharged voltage. If the DC voltage Vbus is zero, the service technician is informed to remove the external energy source 60 and reconnect the high voltage cable 72 to the battery pack 24 at block 126. Alternatively, if the DC voltage Vbus is greater than zero at block 124, the discharge time is compared with a maximum discharge time at block 128. If the discharge time is greater than the maximum discharge time, the vehicle serving method 100 returns to block 122. Alternatively, if the discharge time is not greater than the maximum discharge time, the vehicle servicing method 100 returns to block 120 by rechecking whether the external energy source is turned OFF. The ISC 56 next verifies if the battery pack 24 is connected to the ISC 56 and that the DC voltage V_{bus} is within an expected range at block 130.

If the voltage level is within a predefined range, the ISC 56 commands the contactors 64 to close to connect the battery pack 24 to the high voltage bus 66 at block 132. In one non-limiting embodiment, the closing sequence of the contactors 64 includes closing a main negative contactor 64-1, then closing a precharge contactor 64-2, and then closing a main positive contactor 64-3 and reopening the precharge contactor 64-2 once the DC voltage V_{bus} is close the battery voltage V_{batt} (see FIG. 2).

Finally, at block 134, the engine 14 is commanded to produce torque and generate positive power to charge the battery pack 24 and run any electrical accessories. The ISC 56 may command the motor 22 to operate in a regenerative mode to ramp up the DC voltage V_{bus}. During the battery regenerative charging, the DC current received by the battery pack 24 is monitored to determine whether it is within a defined range. After the battery pack 24 SOC reaches a predefined value, the regen charging is complete and the vehicle servicing method 100 is exited at block 136.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A vehicle servicing method, comprising:
connecting an external energy source to an inverter system controller after disconnecting a high voltage battery pack from a high voltage bus;
starting an engine of the electrified vehicle using energy from the external energy source; and
charging the high voltage battery pack using power from the engine.

2. The method as recited in claim 1, comprising, after starting the engine, commanding a motor to output zero torque such that it is neither generating nor accepting any energy.

3. The method as recited in claim 1, wherein disconnecting the high voltage battery pack includes unplugging a high voltage cable connected to the high voltage battery pack from the inverter system controller.

4. The method as recited in claim 1, comprising, prior to charging the battery pack:
commanding the inverter system controller to discharge a high voltage bus;
disconnecting the external energy source after discharging the high voltage bus;
reconnecting the high voltage battery pack to the high voltage bus prior to charging the high voltage battery pack;
commanding the engine to produce torque; and
commanding the inverter system controller to deliver power to charge the battery pack.

5. The method as recited in claim 1, comprising:
after connecting the external energy source, boosting incoming voltage from the external energy source.

6. The method as recited in claim 1, wherein starting the engine includes:
invoking a low power cranking mode to start the engine; and
declaring the engine started if a speed of the engine exceeds a predefined value.

7. The method as recited in claim 6, comprising:
setting engine to engine speed control; and
setting a motor to torque control mode.

8. The method as recited in claim 1, comprising:
connecting a service tool to the electrified vehicle prior to performing the vehicle servicing method.

9. The method as recited in claim 8, comprising:
communicating messages to a service technician on the service tool.

10. The method as recited in claim 1, wherein charging the high voltage battery pack includes commanding the engine to produce torque and generate power to charge the high voltage battery pack.

11. The method as recited in claim 1, comprising:
discharging the high voltage bus after starting the engine.

12. The method as recited in claim 1, wherein charging the high voltage battery includes closing at least one contactor of the high voltage battery to reconnect the high voltage battery to the high voltage bus.

13. The method as recited in claim 1, wherein the vehicle servicing method is performed in response to an engine fault condition if the high voltage battery pack has an insufficient amount of power necessary to start the engine.

14. A battery charging system using an external energy source, comprising:
a high voltage battery pack;
an engine; and
an inverter system controller configured to start the engine using power from the external energy source during a first step of a vehicle servicing method and supply power from the engine to recharge the high voltage battery pack during a second step of the vehicle servicing method.

15. The system as recited in claim 14, comprising a service tool configured to communicate with said inverter system controller.

16. The system as recited in claim 14, comprising an electric motor configured to start the engine in response to a command from the inverter system controller.

17. The system as recited in claim 14, wherein the external energy source is a separate component from an electrified vehicle but the high voltage battery pack, and the engine and the inverter system controller are each components of the electrified vehicle.

18. The system as recited in claim 14, wherein said high voltage battery pack includes at least one battery cell and at least one contactor.

19. The system as recited in claim 14, wherein the inverter system controller includes a plurality of switching devices configured to control bidirectional flow of power between the high voltage battery pack and the engine.

20. The system as recited in claim 14, wherein the external energy source is a lead acid battery charger.
